(19) United States
(12) Patent Application Publication
(10) Pub. No.: US 2007/0218940 A1
(43) Pub. Date: Sep. 20, 2007

(54) Device and method for automatically selecting a communication band and mode

(75) Inventor: Yung-Sen Lin, Taipei (TW)

Correspondence Address: REED SMITH LLP;Suite 1400, 3110 Fairview Park Drive, Falls Church, VA, 22042, US

(73) Assignee: Acer Incorporated

(21) Appl. No.: 11/491,140

(22) Filed: Jul. 24, 2006

(30) Foreign Application Priority Data
Mar. 15, 2006 (TW) 95108706

(51) Int. Cl. H04M 1/00

(52) U.S. Cl. 455/552.1

(57) ABSTRACT

A wireless communication device and method for automatically selecting a band and mode is provided. Utilizing the global positioning system to obtain the position of the wireless device for simplifying the process of searching service networks and reducing power consumption. Furthermore, a method for a wireless communication device to automatically select a band and mode is also provided.

### FIELD OF INVENTION

The invention is related to the wireless communication engineering, and more particularly related to the technique for automatically selecting a communication band and mode in the field of mobile communication.

### BACKGROUND OF THE INVENTION

For a wireless communication device, like a portable or handheld communication device, such as a mobile phone, Personal Digital Assistants (PDA) or smart phone, manufacturers usually have to emphasize the “standby time” and “talk time” of their products to attract the potential buyers. This is because the space the batteries occupy is indirectly affected as mobile communication devices reducing their sizes for portability. Therefore, besides developing new-typed batteries how to reduce the power dissipation becomes very important with limited battery space.

Referring to FIG. 1, it illustrates a block diagram of a conventional communication device 100. The communication device 100 comprises an antenna 102, a Radio Frequency (RF) transceiver 104, an analog base band processor 106, an application processor 108, a memory 110 and an I/O interface 112. Taking a Global System for Mobile communications (GSM) mobile phone for example, the application processor 108 generates a registration signal passing through the analog base band processor 106, the RF transceiver 104 and the antenna 102 in turn and then transmitted to a base station nearby to perform the location registration procedure when a user pushes the power-on button on the I/O interface 112. The registration signal is subsequently forwarded to a Visitor Location Register (VLR) via the Base Station Controller (BSC), so that the communication network system can acquire the current location information of the communication device 100, and then the talk function of the communication device 100 is able to work.

For multi-band, multi-mode wireless communication devices, such as dual-band, tri-band or quad-band mobile phones that advertised for international roaming convenience, they scan operable bands and modes first to find an available service network and perform the location registration procedure. Referring to FIG. 2 that states the operating processes when a conventional tri-band mobile phone is powered on. After the mobile phone is powered on (step 202), the mobile phone searches for the first frequency band first (step 204), and if the searching succeeds (step 206), the mobile phone sends a network registration signal by using the first frequency band (step 208), and if the network registration succeeds (step 210), the talk function of the mobile phone is enabled (step 212) and then ends (step 232). Backing to the blocks (step 206) and (step 210), if the searching or registration doesn't succeed, the mobile phone searches for the second frequency band (step 214), and if the searching succeeds (step 216), the mobile phone sends a network registration signal by using the second frequency band (step 218), and if the network registration succeeds (220), the talk function of the mobile phone is enabled (step 212) and then ends (step 232). Backing to blocks (step 216) and (step 220), if the searching or registration doesn't success, the mobile phone searches the third frequency band (step 224), and if the searching successes (step 226), the mobile phone sends a network registration signal by using the third frequency band (step 228), and if the network registration successes (step 230), the talk function of the mobile phone is enabled (step 212) and then ends (step 232). Backing to block (step 226) and (step 230), if the searching or registration doesn't succeed, the mobile phone stops the network searching since no service network is available (step 222) and then ends. It is noted from above recitations, when a communication device is scanning available service network, it consumes more power than other common operation from the processes above, that is, comparing to making a call if the mobile phone has already connected to the service network, the searching processes may consume much more battery power.

Furthermore, the scanning processes may be skipped if the user sets up the communication bands and modes used in that communication region the user located by himself/herself, but it requires the user to have knowledge of the communication bands and modes used in that region first. For example, 900 MHz and 1800 MHz are used in Europe region while 850 MHz and 1900 MHz are used in North America for GSM system. Besides, 2100 MHz is used in Europe and pan-Asia region while 850 MHz and 1900 MHz are used in North America, and 1700 MHz will be used in Japan in the future for WCDMA system. Asking users to memorize these complicated system specifications is unfriendly.

Therefore, there is a need for a device and method for automatically helping users select a communication band and mode without scanning the bands and modes.

### SUMMARY OF THE INVENTION

One aspect of the present invention provides a wireless communication device for automatically selecting a communication band and mode, comprising: a Global Positioning System (GPS) module for obtaining a position of the wireless communication device; a memory module having a database, the database storing a plurality of regions, each with a corresponding communication band and mode; a processing module in connection with the GPS module and the memory module, the processing module utilizing the position and the database to select a band and a communication mode used in that position; and a mobile telecommunication module in connection with the processing module, the mobile telecommunication module utilizing the selected communication band and mode to send a registration signal.

Another aspect of the present invention provides a method for a wireless communication device automatically selecting a communication band and mode, the wireless communication device supporting a GPS system and having a database, this method comprising the following steps: (a) obtaining a position of the wireless communication device from the GPS system; (b) querying the database based on the position to select a communication band and mode used in the position; (c) utilizing the selected communication band and mode to send a registration signal of the wireless communication device.

### BRIEF DESCRIPTION OF THE DRAWINGS

FIG. 1 shows a block diagram design of a conventional communication device.

FIG. 2 shows the operating processes of a tri-band mobile phone when the mobile phone is powered on.

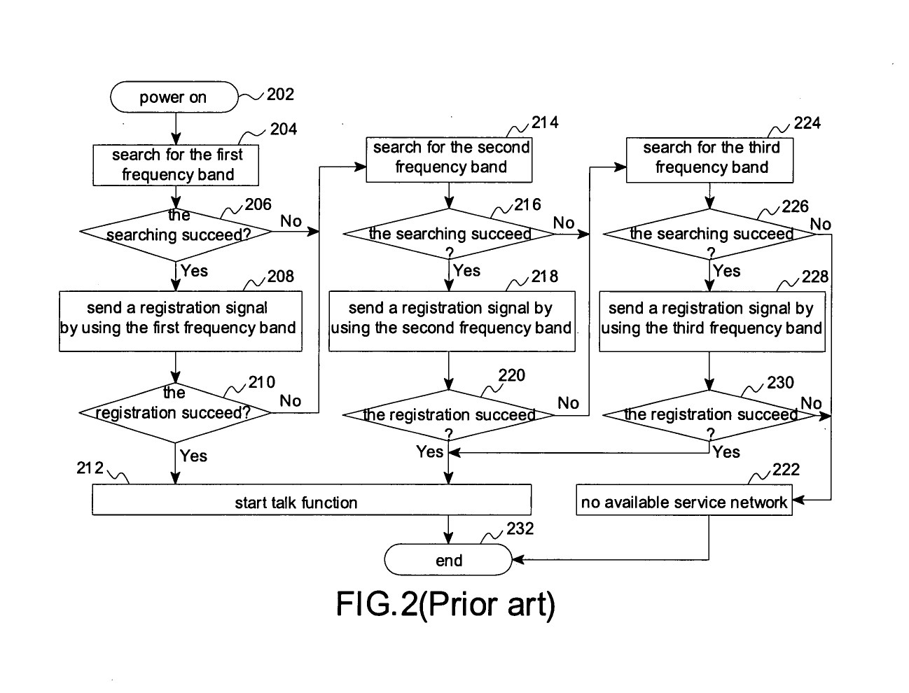

FIG. 3 illustrates a wireless communication device for automatically selecting a communication band and mode in accordance with one embodiment of present invention.

FIG. 4 illustrates a method for a wireless communication device automatically selecting a communication band and mode in accordance with one embodiment of present invention.

### DETAILED DESCRIPTION

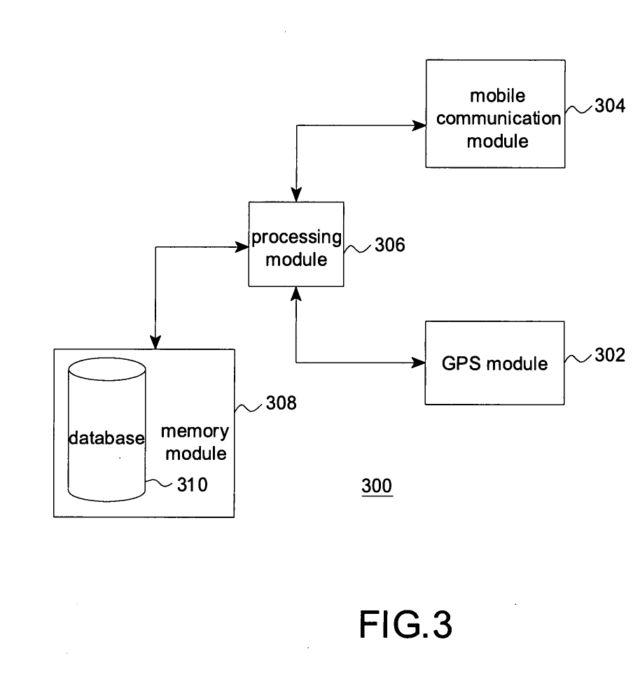

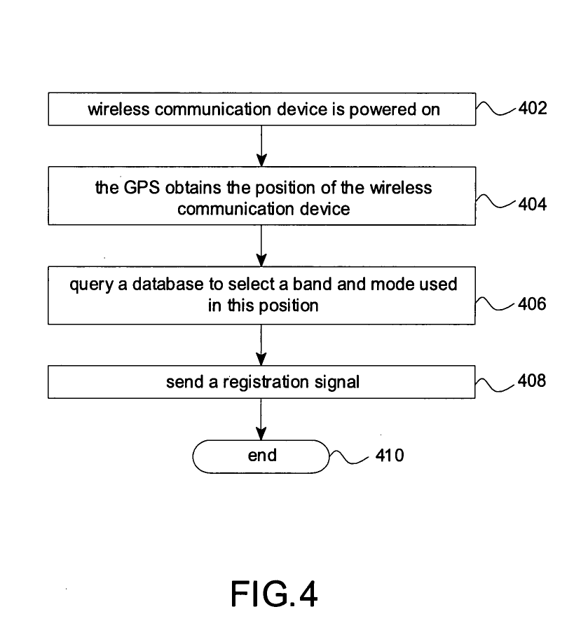

A device and method for automatically selecting a communication band and mode is disclosed. In the following, the present invention can be further understood by referring to the exemplary, but not limiting, description accompanied with the drawings in FIG. 3 and FIG. 4.

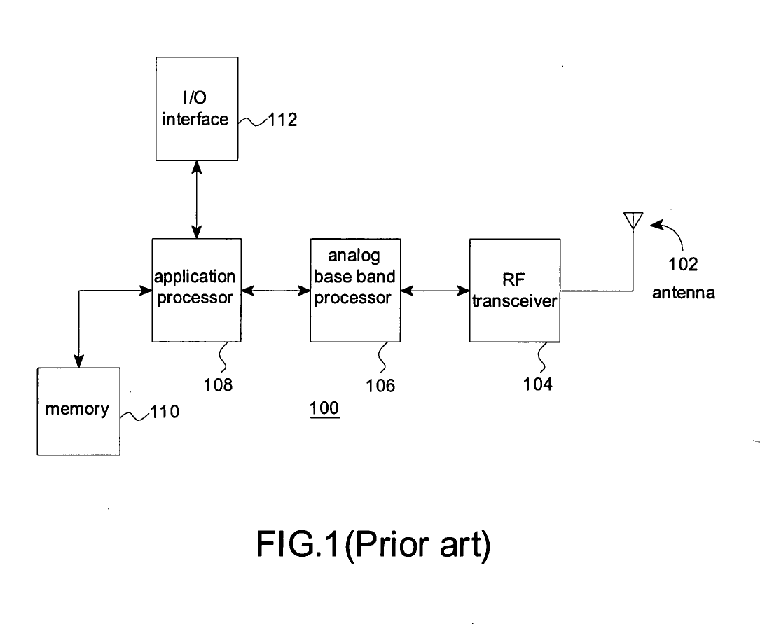

Referring to FIG. 3, a wireless communication device 300 for automatically selecting a communication band and mode in accordance with one embodiment of present invention is disclosed. The wireless communication device 300 includes a GPS module 302, a memory module 308 with a database 310, a processing module 306, and a mobile communication module 304. The GPS module 302 can receive signals from satellites in the space. When receiving signals from three different satellites, the GPS module 302 can get the longitude and latitude (2D) position by calculation, and when receiving a signal from a fourth satellite, it can further get the altitude (3D), and when receiving signals form the 5^{th}, 6^{th} satellites and so on, the precision of the position is enhanced. Generally speaking, whenever and wherever on earth at least four satellites provide GPS signals in the space at the same time, so when the wireless communication device 300 is powered on, the GPS module 302 can be used to provide the current position of the wireless communication device 300. In addition to obtaining the position of the wireless communication device 300, it still needs to know what band and mode to be used in this position. Thus the invention also provides a database 310 within the memory module 308, and the database 310 stores a plurality of communication regions, each with a corresponding communication band and mode. That is, after the GPS module 302 obtains the position of the wireless communication device 300 and notifies the processing module 306, the processing module 306 selects a band and mode used in this position by querying the database 310. Thus the mobile communication module 304, such as the structure shown in FIG. 1, may send a registration signal by using the selected band and mode. However, it should be noticed that the processing module 306 is expressed as one module just for simplicity, and in other embodiments, the processing module 306 may be integrated or incorporated into the mobile communication module 304 or the GPS module 302.

In some embodiments, the memory module 308 further includes a function of recording the positions at which the wireless communication device 300 had roamed. For example, the wireless communication device 300 can use the last position or previous times positions where the wireless communication device 300 is powered on as references for querying the database 310 to facilitate various algorisms application. And, in some embodiments, the database 310 not only stores bands and modes used in different regions but also stores bands and modes used by different service network providers in the same region. Moreover, in some embodiments, the wireless communication device 300 further includes a function of updating the database 310.

Referring to FIG. 4, it illustrates a method for a wireless communication device automatically selecting a communication band and mode in accordance with one embodiment of present invention. First, a wireless communication device is powered on (step 402), and then the GPS obtains the position of the wireless communication device (step 404), and the wireless communication device queries a database to select a band and mode used in this position subsequently (step 406), and the wireless communication sends a registration signal by using the selected band and mode (step 408), and then ends (step 410).

The present invention has been described above with reference to preferred embodiments. However, those skilled in the art will understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

What is claimed is:

1. A wireless communication device for automatically selecting a communication band and mode, comprising:
a Global Positioning System (GPS) module for obtaining a position of said wireless communication device;
a memory module having a database, said database storing a plurality of regions, each with a corresponding communication band and mode;
a processing module in connection with said GPS module and said memory module, said processing module utilizing said position and said database to select a band and a communication mode used in said position; and
a mobile telecommunication module in connection with said processing module, said mobile telecommunication module utilizing said selected communication band and mode to send a registration signal.

2. The wireless communication device of claim 1, wherein said wireless communication device comprises a multi-band, multi-mode, or multi-band multi-mode wireless communication device.

3. The wireless communication device of claim 1, wherein said database comprises a function of updating stored contents in said database.

4. The wireless communication device of claim 1, wherein said memory module further comprises a function of recording said position in said memory module.

5. A method for a wireless communication device automatically selecting a communication band and mode, said wireless communication device supporting a GPS system and having a database, said method comprising the following steps:
(a) obtaining a position of said wireless communication device from said GPS system;
(b) querying said database based on said position to select a communication band and mode used in said position;
(c) utilizing said selected communication band and mode to send a registration signal of said wireless communication device.

6. The method of claim 5, wherein said steps of (a) to (c) are executed when said wireless communication device is powered on.

7. The method of claim 5, wherein said database comprises a function of updating stored contents in said database.

8. The method of claim 5, wherein said step of querying said database further comprises the step of referring to previous positions of said wireless communication device.
